(19) United States
(12) Patent Application Publication
(10) Pub. No.: US 2015/0023558 A1
(43) Pub. Date: Jan. 22, 2015

(54) SYSTEM AND METHOD FOR FACE DETECTION AND RECOGNITION USING LOCALLY EVALUATED ZERNIKE AND SIMILAR MOMENTS

(71) Applicant: Muhittin GOKMEN, (US)

(72) Inventor: Muhittin Gokmen, Istanbul (TR)

(21) Appl. No.: 14/389,456

(22) PCT Filed: Mar. 28, 2013
(86) PCT No.: PCT/IB2013/052503

§ 371 Date: Sep. 30, 2014

(30) Foreign Application Priority Data
Mar. 30, 2012 (TR) 2012/03670

(51) Int. Cl. G06K 9/00; G06K 9/62; G06K 9/46; G06F 17/30

(52) U.S. Cl. CPC G06K 9/00281; G06F 17/30247; G06K 9/6202; G06K 9/4642
USPC 382/103

(57) ABSTRACT

The present invention related to a system (1) and method can be used with the purpose of object, particularly face, detection and recognition in the general sense. The intensive system (1) comprises image acquisition unit (2), object detection unit(3), object image normalization unit (4), object recognition unit (5) and database (V).

### TECHNICAL FIELD

The present invention relates to a system and method which can be used with the purpose of object, particularly face, detection and recognition.

### BACKGROUND OF THE INVENTION

Object recognition, more particularly face recognition, process is one of the most intensive study fields in the field of computer vision. Despite all improvements in recent years, problem of face recognition is still a compelling problem which has not been solved yet entirely. This is mainly because of changes that may occur in appearance of a face due to reasons such as pose and lighting. The most common way to be able to cope with such changes is to prepare features which are not affected by changes. For this purpose, local shape descriptors such as Gabor and LBP (Local Binary Pattern) are intensely used.

Image moments which are strong shape descriptors, are intensely used in solution of pattern recognition problems such as content capture and character recognition. Their activities were presented by introduction of moment invariants which are resistant to changes in size, shifts and rotations by M. Hu for the first time. Zernike moments (ZM) underlying this study were used by A. Khontanzad and Y. H. Hong with the purpose of character recognition and highly successful recognition rates were attained. Other researchers presented ZM based representations resistant to rotation so as to be used in face recognition. Apart from these, it is also possible to mention other face recognition studies which are also prescriptive about use of ZM's and provide localization on certain scales.

In the state of the art, there is no method which enables to calculate Zernike Moments in each pixel on an image locally and thus separate the object image into an image set corresponding to the moment components and thereby to be used in object, more particularly face recognition.

The United States Patent document no. US2010021014, an application in the state of the art, discloses hand-based biometric analysis systems and methods which provide hand-based identification and verification. Within the said method, an image of a hand is obtained and this image is segmented into palm and finger parts. There is no particular orientation or placement restriction for hand during acquisition of the image. The segmentation process is performed without the use of reference points on the image and each segment is analyzed by calculating Zernike moment descriptors specific for that segment. The feature parameters thus obtained are then fused and the fused features obtained are compared to enrolment template descriptors which are stored previously for matching decision.

The Korean Patent document no. KR20060092630, an application in the state of the art, discloses a face recognition method which is carried out using Zernike analysis/LDA (Linear Discriminant Analysis) and a recording medium and is not affected by direction changes of the face wherein moving images such as video broadcasting are present.

### SUMMARY OF THE INVENTION

An objective of the present invention is to realize a system and method which enables to detect image of a specific object located on an image, edit the image detected, carry out necessary processes on the object image so as to make recognition with high efficiency by the image detected.

Another objective of the present invention is to realize a system and method which enables to perform object recognition such that it is resistant to pose and lighting differences.

### DESCRIPTION OF THE INVENTION

“System and Method for Object Detection and Recognition by Local Moments Representation” realized to fulfil the objectives of the present invention is shown in the figures attached, in which:

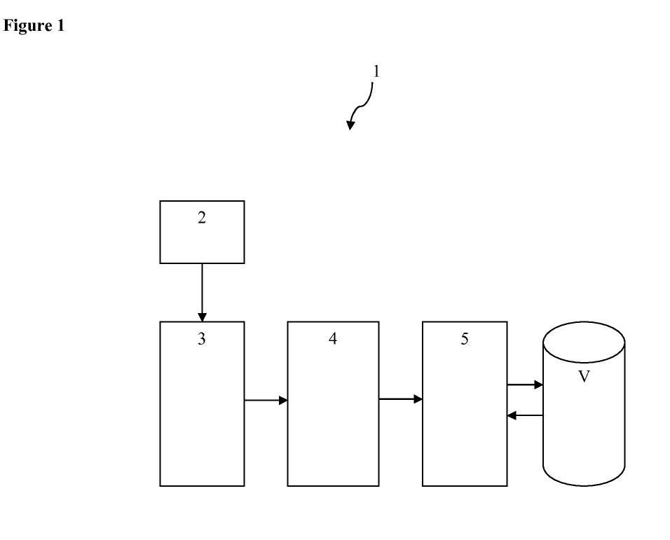

FIG. 1 is a schematic block diagram of the inventive system.

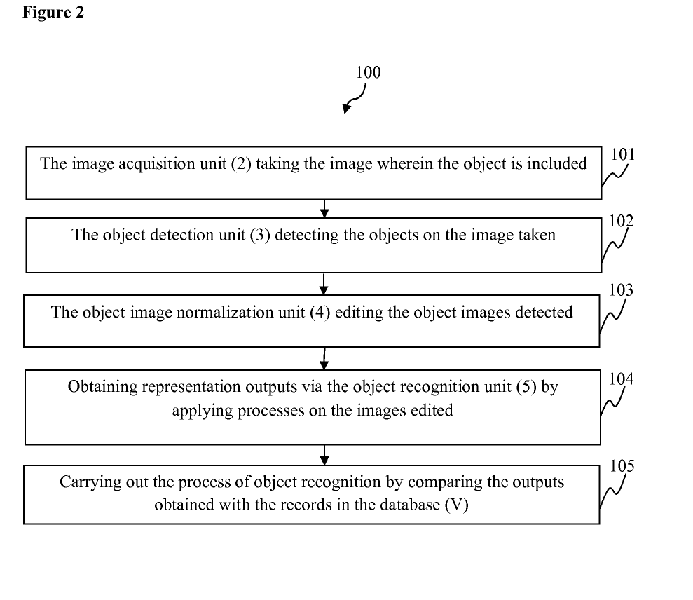

FIG. 2 is a flowchart of the inventive method.

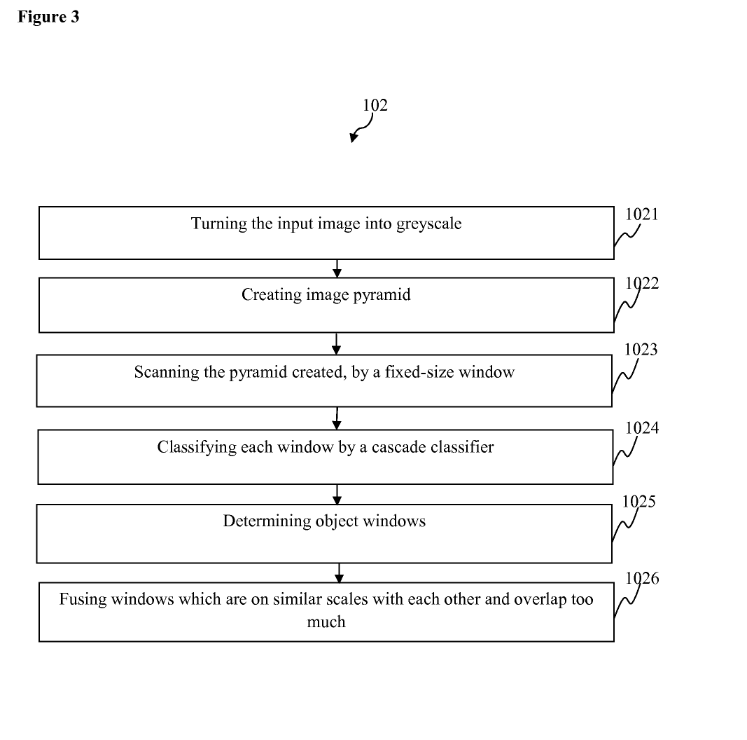

FIG. 3 is a flowchart of the sub-steps of the step of the object detection unit detecting the objects on the image taken, of the inventive method.

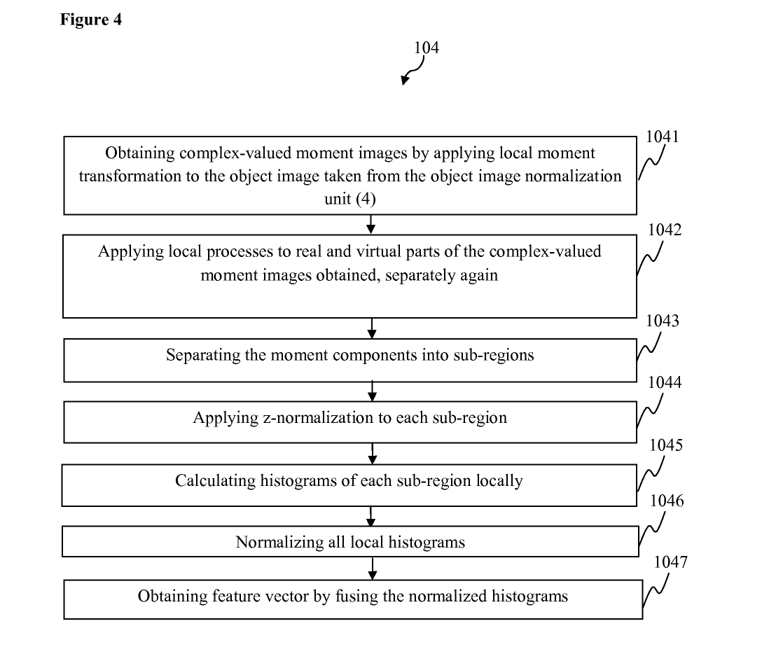

FIG. 4 is a flowchart of the sub-steps of the step of obtaining representation outputs via the object recognition unit by applying processes on the images edited, of the inventive method.

The components illustrated in the figures are individually numbered, where the numbers refer to the following:

1. System

2. Image acquisition unit

3. Object detection unit

4. Object image normalization unit

5. Object recognition unit

100. Method

V. Database

A system (1) which enables to detect and recognize an object on an image comprises:
at least one image acquisition unit (2) which enables to take the image wherein the object is included;
at least one object detection unit (3) which enables to detect a desired object on the image taken from the image acquisition unit (2);
at least one object image normalization unit (4) which enables to edit the objects detected on the image by the object detection unit (3) so as to be used in the process of recognition;
at least one object recognition unit (5) which ensures that objects are recognized by carrying out processes on the images edited by the object image normalization unit (4) and comparing the outputs that are obtained as a result of the processes carried out with the records kept in the database (V)

(FIG. 1).

The image acquisition unit (2) is a unit which enables to take the image wherein the object is included as well, so as to be transmitted to the object detection unit (3). In an embodiment of the invention, the image acquisition unit (2) can be a camera which can take the image from the medium directly or an interface which enables to transmit a pre-recorded image to the object detection unit (3).

The object detection unit (3) is a unit which enables to detect a desired object using cascade-structured classifiers and scanning method on the image taken from the image acquisition unit (2).

The object image normalization unit (4) is a unit which enables to edit, align the object images detected on the image by the object detection unit (3) so as to be used in the process of recognition by considering specific triangulation points.

The object recognition unit (5) is a unit which ensures that objects are recognized by carrying out processes of transformation, segmentation, segmenting into sub-regions, creating histogram and combining histogram on the object images edited by the object image normalization unit (4) and comparing the outputs that are obtained as a result of the processes carried out with the records kept in the database (V).

A method (100) which enables to detect and recognize an object on an image comprises steps of:
the image acquisition unit (2) taking the image wherein the object is included (101);
the object detection unit (3) detecting the objects on the image taken (102);
the object image normalization unit (4) editing the object images detected (103);
obtaining representation outputs via the object recognition unit (5) by applying processes on the images edited (104);
carrying out the process of object recognition by comparing the outputs obtained with the records in the database (V) (105)

(FIG. 2).

The step of the object detection unit (3) detecting the objects on the image taken (102) included in the inventive method (100) comprises sub-steps of:
turning the input image into greyscale (1021);
creating image pyramid (1022);
scanning the pyramid created, by a fixed-size window (1023);
classifying each window by a cascade classifier (1024);
determining object windows (1025);
fusing windows which are on similar scales with each other and overlap too much (1026).

The step of obtaining representation outputs via the object recognition unit (5) by applying processes on the images edited (104) included in the inventive method (100) comprises sub-steps of:
obtaining complex-valued moment images by applying local moment transformation to the object image taken from the object image normalization unit (4) (1041);
applying local processes to real and imaginary parts of the complex-valued moment images obtained, separately again (1042);
separating the moment components into sub-regions (1043);
applying z-normalization to each sub-region (1044);
calculating histograms of each sub-region locally (1045);
normalizing all local histograms (1046);
obtaining feature vector by fusing the normalized histograms (1047).

In the inventive method (100), firstly, the image acquisition unit (2) takes the image wherein the object is included (101). An object may refer to a face, more particularly a human face, in an embodiment of the invention. Whereas an image wherein an object is included describes a photo frame wherein a human face is included, taken as a single frame or taken out of a motion image in an embodiment of the invention. In an embodiment of the invention, the image acquisition unit (2) is a camera and it can directly record an image comprising an object by itself while in another embodiment of the invention it can also serve as an interface taking pre-recorded images. Then, the objects on the image taken are detected by the object detection unit (3) (102). In an embodiment of the invention, local moment representation can be used during detecting the object in the object detection unit (3).

In order that objects are detected by the object detection unit (3), firstly the input image taken by the image acquisition unit (2) is turned into greyscale (1021). Then, an image pyramid is created (1022) and the image pyramid created is scanned by a fixed-size window (1023). Each window scanned is classified by a cascade classifier (1024) and object windows are determined (1025). In an embodiment of the invention, cascade-structured classifiers are the ones which comprise MCT (Modified Census Transform) based characteristics. Whereas in another embodiment of the invention, cascade-structured classifiers are the ones which comprise LBP (Local Binary Patterns) based characteristics. And finally, windows which are on similar scales with each other and overlap too much are fused (1026).

After the object is detected (102), the object image detected is edited by the object image normalization unit (4) (103). This image can be made by finding triangulation points, which belong to the object and determined previously, and taking them as reference. For example, in applications where the object is a face firstly eyes are detected and the face image is rotated such that the eyes will be put on a horizontal axis. Then, mouth is found. In cases where there is a plurality of object images, all object images are edited such that the triangulation points found will get into the same line. A cascade classifier conditioned by these triangulation points in advance is used for finding the triangulation points, used during editing the object image, on the image.

Then, within the method (100), representation outputs are obtained via the object recognition unit (5) by applying processes on the images edited (104). In an embodiment of the invention, while obtaining the representation outputs (104) it can be ensured that the said processes are applied to only pre-determined sections of the object. For example, in cases where the object image is a face image the said processes can only be applied around eye, nose, mouth, or other triangulation points. For these triangulation points, firstly complex-valued moment images are obtained by applying local moment transformation to the object image received from the object image normalization unit (4) (1041). Local moment transformation refers to calculation of moments by considering neighbourhood of that pixel in each pixel on the image. With this process (1041), local shape characteristics of object images are made clear. In a preferred embodiment of the invention, the local moment transformation applied is a Local Zernike Moment (LZM) transformation. In addition to this, local moment transformation can be performed by local calculation of Geometric Cartesian moments, Legendre moments, Pseudo-Zernike moments, Optical moments, Circular Harmonics moments, Spherical Harmonics moments and Monomial moments as well in different embodiments of the invention.

Local processes are applied to real and imaginary parts of the complex-valued moment images obtained, separately again (1042). In an embodiment of the invention, these processes refer to obtaining images comprising complex-valued moment components by applying local moment transformation to real and imaginary parts whereas in another embodiment of the invention, these processes refer to obtaining binary codes from real and imaginary parts. Whereas in a further embodiment of the invention, these processes refer to obtaining LBP-like patterns from real and imaginary parts by local comparisons.

Number of images which are obtained during obtaining images having complex-valued moment components by applying local moment transformation to real and imaginary parts is determined through values of moment degrees. Statistics of shape characteristics, found out previously (1041) with this process (1042), are produced. In an embodiment of the invention, the process of applying local processes again can be carried out such that it will be for one or more times. Then, the moment components are separated into sub-regions (1043). For the process of separating into sub-regions (1043), a two-stage separation is applied using two different grids. In the first stage, the image is separated into N×N number of sub-region with equal size starting from top left point. The N number used in this separation is a parametric value. Whereas in the second stage, the image is separated into (N−1)×(N−1) number of sub-region with equal size which is in same size with the previous ones using a grid shifted from top left point of the image as much as half of a sub-region size. Therefore, N²+(N−1)² number of sub-regions are obtained as a result of the two stages. In addition, different weighting coefficients are assigned to each sub-region according to their significance levels in the recognition process during the process of separating into sub-regions (1043). In an embodiment of the invention, these coefficients can be used by calculating different coefficients for each moment in each sub-region instead of sub-regions. After the sub-regions are obtained (1043), z-normalization is applied to each sub-region (1044). With the application of z-normalization (1043) it is ensured that susceptibility to lighting differences is reduced. Afterwards, histograms of each sub-region are calculated locally (1045). In a preferred embodiment of the invention, these histograms calculated are phase-amplitude histograms (PAH). In another embodiment of the invention, only amplitude histograms can be calculated locally. PAHs used in the preferred embodiment are created by dividing phase range of [0, 2π] into b number of bins and adding amplitude value of each (i,j) pixel in the image to the histogram bin corresponding to the angle of this pixel. Values of b, i and j refer to one variable. Then, all local histograms are normalized (1046) and the feature vector is obtained by fusing the histograms normalized (1047). The process of fusing histograms is carried out by adding the histograms successively. In a preferred embodiment of the invention, the value (N) determining the grid size is 10, the value (b) determining the number of bin in the histograms is 24, the values determining the YZM core lengths in each YZM transformation are 5 and 7, and the values determining the moment degrees are 4 and 4.

Within the method (100), it is ensured that the process of object recognition is carried out by comparing the feature vector obtained with the records in the database (V) (105) lastly. In an embodiment of the invention, for the comparison process (105) algorithm of 1−NN (use of the Nearest K-Neighbour algorithm by the value of K=1) is used. In another embodiment of the invention, sizes of the outputs obtained are reduced using size reduction methods for the comparison process. The said size reduction methods are methods of Subsampling, Principal Component Analysis (PCA), Linear Discriminant Analysis (LDA) and Locality Preserving Projection (LPP). In addition, results of the recognition processes carried out in the previous frames are also taken into consideration during comparison. Thus, it is ensured that sensitivity to errors that may occur during the processes of detection (102) or editing (103) are reduced.

The object recognition unit (5) included in the inventive system (1) is adapted to perform processes of:
applying local moment transformation to the object image;
applying local processes to real and imaginary parts of the moment images separately again;
separating the moment components into sub-regions;
applying z-normalization to each sub-region;
calculating histograms of each sub-region locally;
normalizing all local histograms;
obtaining feature vector by fusing the histograms normalized.

With the inventive system (1) and method (100), processes of: detecting image of a specific object on an image, editing the image detected, carrying out necessary processes on an object image so as to make a recognition with high efficiency by the image detected are carried out. When the said processes are carried out: the image acquisition unit (2) takes the image wherein the object is included, the object detection unit (3) detects the objects on the image, the object images detected are edited by the object image normalization unit (4), representation outputs are obtained by applying processes on images edited by the object recognition unit (5), the process of object recognition is carried out by comparing the outputs obtained with the records kept in the database (V).

In the inventive system (1) and method (100), the process of performing object recognition such that it is resistant to pose and lighting differences is carried out. When the said process is carried out: complex-valued moment images are obtained by applying local moment transformation to the object image taken from the object image normalization unit (4); images comprising complex-valued moment images are obtained by applying local moment transformation to real and imaginary parts of the complex-valued moment images obtained, separately again. Then, the moment components are separated into sub-regions; z-normalization is applied to each sub-region; and the process of calculating histograms of each sub-region locally is carried out. Afterwards, all local histograms are normalized; feature vector is obtained by fusing the histograms normalized; and finally, it is ensured that the process of object recognition is carried out by comparing these vectors with the records in the database (V).

It is possible to develop various embodiments of the inventive system (1) and method (100), it cannot be limited to examples disclosed herein and it is essentially according to claims.

1. A method (100) which enables to detect and recognize an object on an image characterized by steps of:
the image acquisition unit (2) taking the image wherein the object is included (101);
the object detection unit (3) detecting the objects on the image taken (102);
the object image normalization unit (4) editing the object images detected (103);
obtaining representation outputs via the object recognition unit (5) by applying processes on the images edited (104);
carrying out the process of object recognition by comparing the outputs obtained with the records in the database (V) (105).

2. A method (100) according to claim 1, characterized in that an object refers to a face.

3. A method (100) according to claim 1 or 2, characterized in that at the step of the object detection unit (3) detecting the objects on the image taken (102); local moment representation is used during object detection in the object detection unit (3).

4. A method (100) according to any of the preceding claims, characterized in that at the step of the object image normalization unit (4) editing the object images detected (103); the object image is made through alignment by finding triangulation points, that belong to the object and are determined previously, and taking them as reference.

5. A method (100) according to any of the preceding claims, characterized in that at the step of the object image normalization unit (4) editing the object images detected (103); in applications where the object is a face firstly eyes are detected, the face image is rotated such that the eyes will be put on a horizontal axis, then alignment is made by finding the mouth.

6. A method (100) according to any of the preceding claims, characterized in that at the step of the object image normalization unit (4) editing the object images detected (103); in order to find the triangulation points to be used for editing on the image a cascade classifier conditioned by these triangulation points in advance is used.

7. A method (100) according to any of the preceding claims, characterized in that at the step of obtaining representation outputs via the object recognition unit (5) by applying processes on the images edited (104); the said processes are applied to only pre-determined sections of the object.

8. A method (100) according to any of the preceding claims, characterized in that at the step of carrying out the process of object recognition by comparing the outputs obtained with the records in the database (V) (105); algorithm of 1−NN (use of the Nearest K-Neighbour algorithm by the value of K=1) is used for the comparison process (105).

9. A method (100) according to any of the preceding claims, characterized in that at the step of carrying out the process of object recognition by comparing the outputs obtained with the records in the database (V) (105); size reduction methods are used.

10. A method (100) according to any of the preceding claims, characterized in that at the step of carrying out the process of object recognition by comparing the outputs obtained with the records in the database (V) (105); results of the recognition processes carried out in the previous frames are also taken into consideration during comparison.

11. A method (100) according to any of the preceding claims, which enables to detect the objects on the image taken by the object detection unit (3) characterized by sub-steps of:
turning the input image into greyscale (1021);
creating image pyramid (1022);
scanning the pyramid created, by a fixed-size window (1023);
classifying each window by a cascade classifier (1024);
determining object windows (1025);
fusing windows which are on similar scales with each other and overlap too much (1026).

12. A method (100) according to claim 11, characterized in that at the step of classifying each window by a cascade classifier (1024); cascade-structured classifiers are the ones which comprise MCT (Modified Census Transform) based characteristics.

13. A method (100) according to claim 11, characterized in that at the step of classifying each window by a cascade classifier (1024); cascade-structured classifiers are the ones which comprise LBP (Local Binary Patterns) based characteristics.

14. A method (100) according to any of the preceding claims, which enables to obtain representation outputs via the object recognition unit (5) by applying processes on the images edited; characterized by sub-steps of:
obtaining complex-valued moment images by applying local moment transformation to the object image taken from the object image normalization unit (4) (1041);
applying local processes to real and imaginary parts of the complex-valued moment images obtained, separately again (1042);
separating the moment components into sub-regions (1043);
applying z-normalization to each sub-region (1044);
calculating histograms of each sub-region locally (1045);
normalizing all local histograms (1046);
obtaining feature vector by fusing the normalized histograms (1047).

15. A method (100) according to claim 14, characterized in that at the step of obtaining complex-valued moment images by applying local moment transformation to the object image taken from the object image normalization unit (4) (1041); local moment transformation refers to calculation of moments by considering neighbourhood of that pixel in each pixel on the image.

16. A method (100) according to claim 14 or 15, characterized in that at the step of obtaining complex-valued moment images by applying local moment transformation to the object image taken from the object image normalization unit (4) (1041); the local moment transformation applied is a Local Zernike Moment (LZM) transformation.

17. A method (100) according to claim 14 or 15, characterized in that at the step of obtaining complex-valued moment images by applying local moment transformation to the object image taken from the object image normalization unit (4) (1041); the local moment transformation applied can be performed by local calculation of one of the moments of Geometric Cartesian moments, Legendre moments, Pseudo-Zernike moments, Optical moments, Circular Harmonics moments, Spherical Harmonics moments and Monomial moments.

18. A method (100) according to any of claims 14 to 17, characterized in that at the step of applying local processes to real and imaginary parts of the complex-valued moment images obtained, separately again (1042); images comprising complex-valued moment components are obtained by applying local moment transformation to real and imaginary parts separately.

19. A method (100) according to any of claims 14 to 18, characterized in that at the step of applying local processes to real and imaginary parts of the complex-valued moment images obtained, separately again (1042); number of images acquired during obtaining images having complex-valued moment components by applying local moment transformation to real and imaginary parts separately, is determined through values of moment degrees.

20. A method (100) according to any of claims 14 to 17, characterized in that at the step of applying local processes to real and imaginary parts of the complex-valued moment images obtained, separately again (1042); binary codes are obtained from real and imaginary parts.

21. A method (100) according to any of claims 14 to 17, characterized in that at the step of applying local processes to real and imaginary parts of the complex-valued moment images obtained, separately again (1042); LBP-like patterns are obtained from real and imaginary parts separately by local comparisons.

22. A method (100) according to any of claims 14 to 21, characterized in that at the step of applying local processes to real and imaginary parts of the complex-valued moment images obtained, separately again (1042); the process of applying local processes again can be carried out such that it will be for one or more times.

23. A method (100) according to any of claims 14 to 22, characterized in that at the step of separating the moment components into sub-regions (1043); a two-stage separation is applied using two different grids for the process of separating into sub-regions (1043).

24. A method (100) according to any of claims 14 to 23, characterized in that at the step of separating the moment components into sub-regions (1043); in the first stage, the image is separated into N×N number of sub-region starting with equal size from top left point.

25. A method (100) according to any of claims 14 to 24, characterized in that at the step of separating the moment components into sub-regions (1043); in the second stage, the image is separated into (N−1)×(N−1) number of sub-region with equal size which are in dimensions same with the previous ones using a grid shifted from top left point of the image as much as half of a sub-region dimension.

26. A method (100) according to any of claims 14 to 25, characterized in that at the step of separating the moment components into sub-regions (1043); the N number is a parametric value.

27. A method (100) according to any of claims 14 to 26, characterized in that at the step of separating the moment components into sub-regions (1043); different weighting coefficients are assigned to each sub-region according to their significance levels in the recognition process.

28. A method (100) according to any of claims 14 to 27, characterized in that at the step of calculating histograms of each sub-region locally (1045); the histograms calculated are phase-amplitude histograms (PAH).

29. A method (100) according to any of claims 14 to 28, characterized in that at the step of calculating histograms of each sub-region locally (1045); the histograms calculated are amplitude histograms.

30. A method (100) according to any of claims 14 to 29, characterized in that at the step of obtaining feature vector by fusing the histograms normalized (1047);
the process of fusing histograms is carried out by adding the histograms successively.

31. A system (1) which enables to detect and recognize an object on an image comprising:
at least one image acquisition unit (2) which enables to take the image wherein the object is included;
at least one object detection unit (3) which enables to detect a desired object on the image taken from the image acquisition unit (2);
at least one object image normalization unit (4) which enables to edit the objects detected on the image by the object detection unit (3) so as to be used in the process of recognition;
and characterized by
at least one object recognition unit (5) which ensures that objects are recognized by carrying out processes on the images edited by the object image normalization unit (4) and comparing the outputs that are obtained as a result of the processes carried out with the records kept in the database (V).

32. A system (1) according to claim 31, characterized by the image acquisition unit (2) which is a camera.

33. A system (1) according to claim 32, characterized by the image acquisition unit (2) which is an interface for transmitting a pre-recorded image to the object detection unit (3).

34. A system (1) according to any of claims 31 to 33, characterized by an object recognition unit (5) which is adapted to perform processes of:
applying local moment transformation to the object image;
applying local processes to real and imaginary parts of the moment images separately again;
separating the moment components into sub-regions;
applying z-normalization to each sub-region;
calculating histograms of each sub-region locally;
normalizing all local histograms;
obtaining feature vector by fusing the histograms normalized.
